(19) United States
(12) Patent Application Publication
(10) Pub. No.: US 2006/0219542 A1
(43) Pub. Date: Oct. 5, 2006

(54) Application sensitive illumination system and method for a mobile computing device

(75) Inventor: Lahav Savir, Moshav Lachish (IL)

Correspondence Address: F. JASON FAR-HADIAN;CENTURY IP LAW GROUP, PO BOX 7333, NEWPORT BEACH, CA, 92658-7333, US

(73) Assignee: IXI Mobile (R&D) Ltd.

(21) Appl. No.: 11/097,643

(22) Filed: Apr. 1, 2005

(51) Int. Cl. H01H 9/00

(52) U.S. Cl. 200/314

(57) ABSTRACT

An application sensitive illumination method for a mobile device is provided. The method comprises detecting whether a first application is launched; determining a first set of keys of the mobile device associated with the first application; illuminating the first set of keys; detecting whether a second application is launched; determining a second set of keys of the mobile device associated with the second application; illuminating the second set of keys; and un-illuminating the first set of keys.

### COPYRIGHT & TRADEMARK NOTICES

A portion of the disclosure of this patent document contains material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is for providing an enabling disclosure by way of example and shall not be construed to limit the scope of this invention to material associated with such marks.

### BACKGROUND

1. Field of Invention

The present invention relates generally to an illumination mechanism for a mobile device and, more particularly, to controlling the backlight for a mobile communication device by way of detecting changes in application execution environment of the mobile communication device.

2. Related Art

Mobile communication devices such as cellular telephones and personal digital assistants (PDAs) are now equipped with sophisticated user interfaces such as extended keypads or even full keyboards. Some also include joystick or other directional pointing devices that allow a user to control the position of a pointer, entry field, or cursor on the device's display.

The user interface design for such phones is implemented to accommodate a user that utilizes the device for various applications, such as making a phone call, entering contact information, or browsing the Internet, for example. Since some application may be controlled by a limited number of keys on the keypad, a few of the devices use color coding to distinguish different areas of the keypad that are exclusively used for different applications.

For example, some PDA devices mark certain keys on the keypad that are associated with a number with a first color, or keys that perform special functions with a second color. This color-coding helps the user to easily distinguish keys with different functions. The color-coding scheme, while useful, is limited in that it can be used to distinguish a few sets of keys. Unfortunately, however, if the device supports a larger number of applications, then the color-coding of each key on the device's user interface becomes problematic and confusing for the user.

Even further, the color-coding scheme is not easily ascertainable in dark environments, unless a backlight unit of the device is used to illuminate the keypad. Regardless, since the backlight illuminates all the keys on the keypad, it is hard to distinguish the color-coded keys from one another. As such, there is a need for an improved method of distinguishing user interface features associated with various application execution environments.

### SUMMARY

The present disclosure is directed to a system and corresponding methods for controlling an illumination mechanism of a mobile communication device.

For the purpose of summarizing, certain aspects, advantages, and novel features of the invention have been described herein. It is to be understood that not all such advantages may be achieved in accordance with any one embodiment of the invention. Thus, the invention may be embodied or carried out in a manner that achieves or optimizes one advantage or group of advantages as taught herein without achieving other advantages as may be taught or suggested.

In accordance with one or more embodiments, a method for controlling an illumination system for a mobile device is provided. The method comprises detecting whether a first application is launched; determining a first set of user interfaces of the mobile device associated with the first application; and adjusting illumination of one or more illumination mechanisms that illuminate said first set of user interfaces of the mobile device.

In one embodiment, the adjusting comprises increasing illumination intensity of the one or more illuminating mechanisms. In another embodiment, the adjusting comprises decreasing illumination intensity of the one or more illuminating mechanisms. In yet another embodiment, the adjusting comprises changing illumination color of the one or more illuminating mechanisms.

The method may further comprise detecting whether a second application is launched; determining a second set of user interfaces of the mobile device associated with the second application; and adjusting illumination of one or more illumination mechanisms that illuminate said second set of user interfaces of the mobile device.

The illumination of the one or more illumination mechanisms is returned to a default illumination state when the first application is closed. The one or more illumination mechanisms may comprise one or more backlights for lighting said first set of user interfaces. At least one of the illumination mechanisms is a light emitting diode (LED), for example. In certain embodiments, the user interfaces comprise one or more keys on a keypad of the mobile device and direction control means of the mobile device, for example.

In accordance with yet another embodiment, an application sensitive illumination method for a mobile device comprises detecting whether a first application is launched; determining a first set of keys of the mobile device associated with the first application; illuminating the first set of keys; detecting whether a second application is launched; determining a second set of keys of the mobile device associated with the second application; illuminating the second set of keys; and un-illuminating the first set of keys.

These and other embodiments of the present invention will also become readily apparent to those skilled in the art from the following detailed description of the embodiments having reference to the attached figures, the invention not being limited to any particular embodiments disclosed.

### BRIEF DESCRIPTION OF THE DRAWINGS

Embodiments of the present invention are understood by referring to the figures in the attached drawings, as provided below.

FIG. 1 illustrates an exemplary environment in which an application sensitive illumination mechanism may be utilized, in accordance with one embodiment of the invention;

FIG. 2 is a block diagram of an exemplary illumination mechanism, in accordance with one or more embodiments;

FIG. 3 is a flow diagram of a control method for the exemplary illumination mechanism illustrated in FIG. 2, in accordance with one or more embodiments; and

FIGS. 4A and 4B are block diagrams of hardware and software environments in which a system of the present invention may operate, in accordance with one or more embodiments.

Features, elements, and aspects of the invention that are referenced by the same numerals in different figures represent the same, equivalent, or similar features, elements, or aspects, in accordance with one or more embodiments.

### DETAILED DESCRIPTION

A control system and corresponding methods, according to an embodiment of the present invention, facilitate the operation and provide an illumination system for a mobile device so that user interface components of the device are illuminated in accordance with the type of the application software being executed or activated on the mobile device at different time intervals. The illumination system may be implemented in form of a background or foreground lighting system embedded in or otherwise attached to the mobile device.

Numerous specific details are set forth to provide a thorough description of various embodiments of the invention. Certain embodiments of the invention, however, may be practiced without these specific details or with some variations in detail.

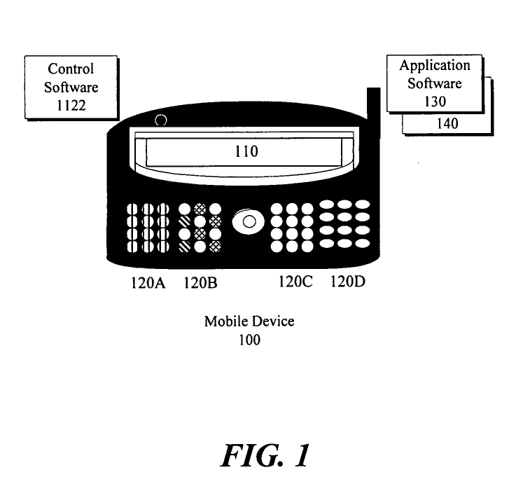

Referring to FIG. 1, in accordance with one or more embodiments of the invention, a mobile device 100 comprises user interface components 110 and 120. User interface components 110 and 120 allow the user to view or input data. As shown, the user interface may comprise a display screen 110 and a set of keypads 120A, 120B, 120C, and 120D, for example.

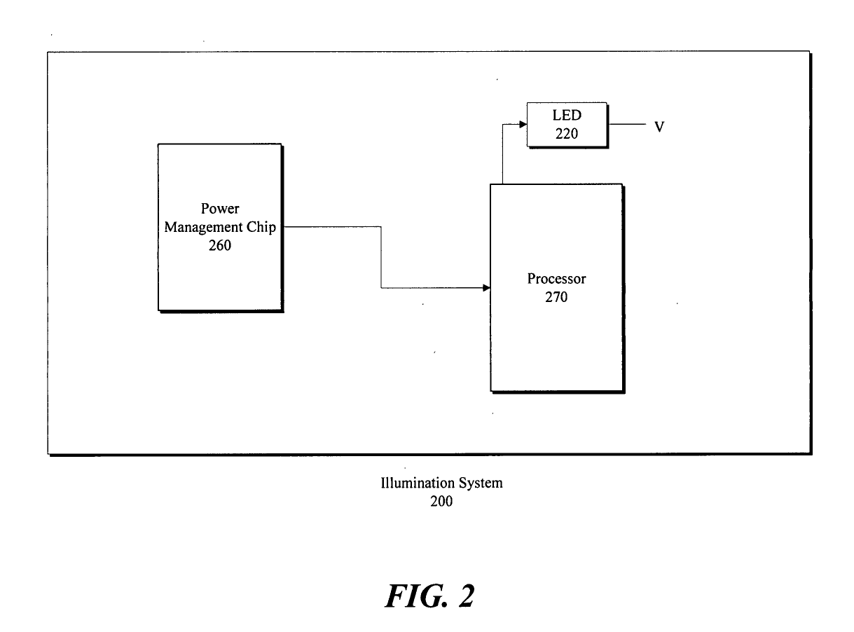

Mobile device 100, in one embodiment, further comprises an illumination system 200 (see FIG. 2) for illuminating the mobile device 100's user interface components, in accordance with instructions received from control software 1122. The illumination enhances a user's ability to view and interact with the mobile device 100's user interface.

In certain embodiments, control software 1122 is executed on mobile device 100 to detect the launch or the active execution status of various application software 130 or 140, for example, on mobile device 100. That is, control software 1122 is implemented to detect when an application software is being used and control illumination system 200 to activate or deactivate certain keys on keypad 120 in accordance with the specific features of the respective application software used at the time.

As such, control software 1122 is stored in and/or executed on mobile device 100 to control the operation and functional features of illumination system 200 and one or more of its components. Control software 1122, for example, may be comprised of one or more modules that are executed on one or more computing systems in an integrated or distributed environment, as provided in further detail below.

In the following, one or more embodiments of the invention are disclosed, by way of example, as applicable to a method of controlling the illumination system 200 in a mobile device based on the nature and type of application software 130, 140 executed on mobile device 100. It is noteworthy that the same or a similar implementation may be applied to a method for controlling an illumination system 200 on any computing system or device.

One of ordinary skill in the art will appreciate that mobile device 100, in accordance with one embodiment, may be connected to one or more types of networks (e.g., personal area networks, local area networks, cellular communications networks, personal mobile gateways, etc.) without limiting the scope of the invention. The terms “connected,” “coupled,” or any variant thereof, mean any connection or coupling, either direct or indirect, between two or more elements. The coupling or connection between the elements can be physical, logical, or a combination thereof.

In one embodiment, mobile device 100 may comprise one or more means of wireless communication. Wireless communication technologies suited for connecting wireless devices in short-range area networks (i.e., IEEE 802.11 or Bluetooth), and long-range area networks (i.e., GSM, UMTS, WCDMA, etc.) and the like may be utilized to connect mobile device 100 to other mobile devices or wireless infrastructure components, for example. Mobile device 100, in one or more embodiments, can be a cellular telephone, a personal digital assistant (PDA), a laptop computer, or other computing or processing machine capable of data storage and data communication, for example.

Referring to FIG. 2, in one or more embodiments, illumination system 200 comprises one or more electrical modules or components, such as an illuminating mechanism 220, a power management chip 260, and a processor 270. Reference to illuminating mechanism 220 is made in the singular form through out this disclosure. In alternative embodiments of the invention, however, any number of illuminating mechanisms 220, either alone or in combination, may be utilized depending on implementation.

Illuminating mechanism 220 may be a light emitting diode (LED), an electro luminescent (EL), or other light producing means that can be turned on or off, or controlled to emanate light. It is noteworthy that illuminating system 200 may comprise software or hardware modules, such as power amplifiers, transistors, field effect transistors (FETs), etc. that can be used instead, in conjunction or in combination with the light emitting mechanism 220 to accomplish the results contemplated herein.

In accordance with one aspect of the invention, illuminating mechanism 220 is hereafter referred to by way of example as “LED 220.” In the exemplary embodiment illustrated in FIG. 2, power management chip 260 may be a semiconductor device, or other logic module implemented in hardware, software or a combination of the two. For example, in one embodiment, power management chip 260 may comprise a programmable logic device (PLD) (e.g., a field programmable gate array (FPGA), an application specific integrated circuit (ASIC), etc.).

Referring to FIGS. 1 and 2, in one embodiment, control software 1122 in response to detecting the launch or activation of a first application (e.g., application software 130) causes a signal to be provided to at least one of LED 220, power management chip 260, or processor 270 by controlling a switch, for example. The signal generated as the result, provides information about the keys on the keypad 120 or other user interfaces that are associated with the first application.

For example, if application software 130's functionality is limited to providing an interface for dialing a phone number, then keys associated with application software 130 may comprise the keys on keypad 120D marked with the numbers 0 through 9. In another example, if control software 1122 detects the launch or activation of application software 140 used for entering text messages, for example, then keys associated with application software 140 may comprise keys on keypads 120A and 120C, for example, that are marked with alphabetic characters A through Z.

In accordance with one aspect of the present invention, an application software is considered to be launched when the respective executable file or files are loaded into a memory of mobile device 100 or executed by processor 270. An application software is considered to be activated when data or information associated with the application software are inputted by way of user interface devices of mobile device 100, or when a graphic user interface associated with the application software is displayed on screen 110.

Thus, once control software 1122 detects the launch or activation of application software 130 or 140, then control software 1122 controls illumination system 200 or one or more of its components. This is done by way of one or more control signals that cause one or more keys or sets of keys associated with the active or launched application software to illuminate. In an exemplary embodiment of mobile device 100, when application software 130 is activated or launched then a first set of keys (e.g., 120A) is illuminated, and when application software 140 is activated or launched, then a second set of keys (e.g., 120D) is illuminated by way of one or more LEDs 220, for example.

In one embodiment, processor 270 is a microprocessor or a microcontroller designed and developed by Texas Instruments Inc., Motorola Inc., or other chipmakers. Processor 270 operates based on instructions provided by control software 1122 and/or one or more control signals produced by power management chip 260, for example, to determine the activation time or intensity of LED 220's illumination. One skilled in the art would appreciate that other functional equivalent signal processing modules may be utilized to perform the signal processing in alternative embodiments.

Control software 1122 may comprise one or more software modules or may be implemented in form of one or more hardware modules, or a combination of hardware and software. These modules are collectively or individually executed on processor 270 and/or power management chip 260 to perform the related control and illumination functions. In one or more embodiments, a control mechanism such as control software 1122 in conjunction with power management chip 260 and processor 270 is implemented to control LED 220 luminance, according to control signals generated by power management chip 260.

It is noteworthy that the hardware components illustrated in FIG. 2, such as power management chip 260 and processor 270 may be implemented in accordance with one or more embodiments, as hardware or software modules, a combination of the two, or alternative embodiments that accomplish the same functions. For example, in one embodiment, power management chip 260 can be implemented as an analog to digital (A/D) converter for converting the signal generated according to control software 1122 to a second signal representing the type of software application launched or activated.

In accordance with one embodiment, when the launch or activation of application software 130, for example, is detected, then LED 220 for the respective keys or user interfaces is turned on; and LED 220 for other keys or user interfaces remains off. As an alternative to switching the LED 220 on or off, power management chip 260 may be implemented to control the illumination intensity of LED 220.

For example, if control software 1122 detects launch or activation of two application software, then illumination intensity of LED 220 for a first set of keys (e.g., 120A) associated with application software 130, for example, may be set at a first level (e.g., bright) and illumination intensity of LED 220 for a first set of keys (e.g., 120D) associated with application software 140, for example, may be set at a second level (e.g., dim). Thus, various illumination states may be implemented for various sets of keys depending on implementation.

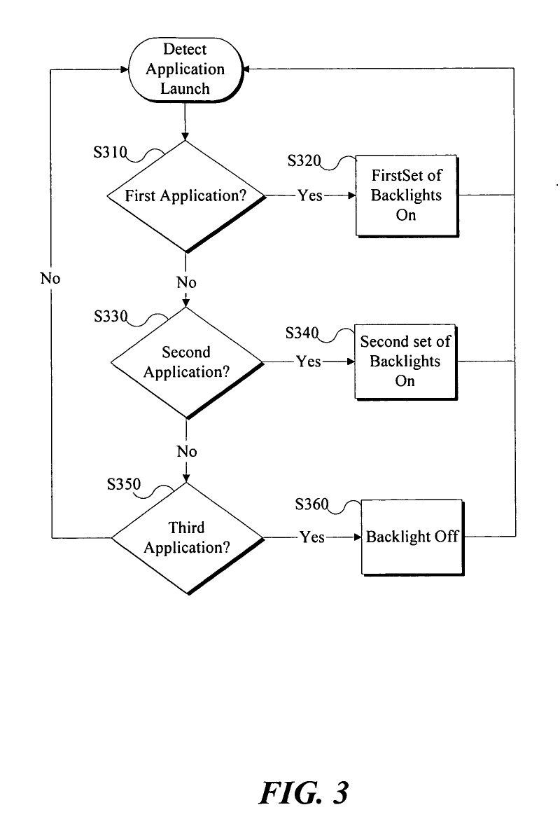

Referring to FIG. 3, an exemplary method for controlling the operation of illumination system 200 is provided. It should be noted that part or all of this exemplary method may be implemented as logic code in hardware, software or a combination of the two. In one embodiment, the method illustrated in FIG. 3 is implemented in form of control software 1122, by way of example, for controlling the backlight for a screen 110 or keypad 120.

Referring to FIGS. 1, 2 and 3, in an exemplary embodiment of the invention, control software 1122 provides instructions to processor 270 (in conjunction with power management chip 260) based on detecting a certain application software being launched or activated. For example, if control software 1122 determines that application software 130 is activated (S310), then a first set of backlights (e.g., LEDs 220) associated with application software 130 are turned on (S320).

If control software 1122 detects the activation or launch of a second application software 140 (S330), for example, then control software 1122 causes a second set of backlights associated with application software 140 to be turned on (S340). In one embodiment, control software 1122 causes the first set of backlights associated with the first application software 130 to be turned off, when the second set of backlights associated with application software 140 are turned on.

In some embodiments, a third application software maybe activated or launched such that no sets of keys are associated with it. As such, when control software 1122 detects the third application (S350), then all backlights for mobile device 100's keypad 120 are turned off (S360), while one or more other user interfaces (e.g., display screen 110) may remain turned on, for example.

FIG. 3 represents an exemplary method implemented to control the illumination system 200 of the present invention in accordance with one embodiment. In other embodiments, different logic and control orders may be implemented to accomplish the same or similar results. As noted earlier, illumination system 200 may be designed to control the illumination intensity of the backlight (e.g., LED 220), instead of simply turning it on and off. As such, the backlight illumination may be changed in degradations according to changes in the detected level of movement.

For example, instead of turning the backlight on, illumination system 200 may gradually increase the intensity of the backlight, until a maximum threshold is exceeded. A reverse method for reducing the intensity of backlight can be implemented in other embodiments, so that the backlight's luminance is gradually decreased to a minimum (e.g., zero), instead of turning the backlight off.

As such, alternative embodiments of the invention may be implemented to control the illumination of the user interface components, such as screen 110 and keypad 120, based on the activation or launch status of one or more application software. Thus, instead of turning the respective backlights for each user interface on and off, each backlight is gradually made brighter or dimmer.

In one embodiment, if mobile device 110 is not used for a predetermined time, for example, then control software 1122 may determine that a launched or active application is no longer being used. Therefore, control software 1122 will cause LED 220 to be turned off. If a user interacts with mobile device 100, then control software 1122 will detect a change in status and will cause LED 220 to illuminate the previously illuminated keys, for example.

A similar scheme may be applied to activate or deactivate a lock mechanism for certain sets of keys of mobile device 100. Thus, for example, if a first application software is in use the first set of keys (e.g., 120A) associated therewith will have an unlock status, while other sets of keys (e.g., 120B, 120C, or 120D) remain locked. In certain embodiment, an active application software may be associated with a few keys, rather than a set of keys (see for example 4 keys illustrated in gray in set of keys 120B). Thus, control software 1122 may control illumination system 200 to illuminate a few selected keys rather than a cluster of keys such as key sets 120A, 120B, 120C or 120D.

In some embodiments, the control, monitoring and detecting functions discussed above in relation to control software 1122 are implemented in hardware, or a combination of hardware and software. As such, although control software 1122 is disclosed as applicable to the system of the present invention, this application is by way of example and shall not be construed to limit the scope of the invention to a software solution.

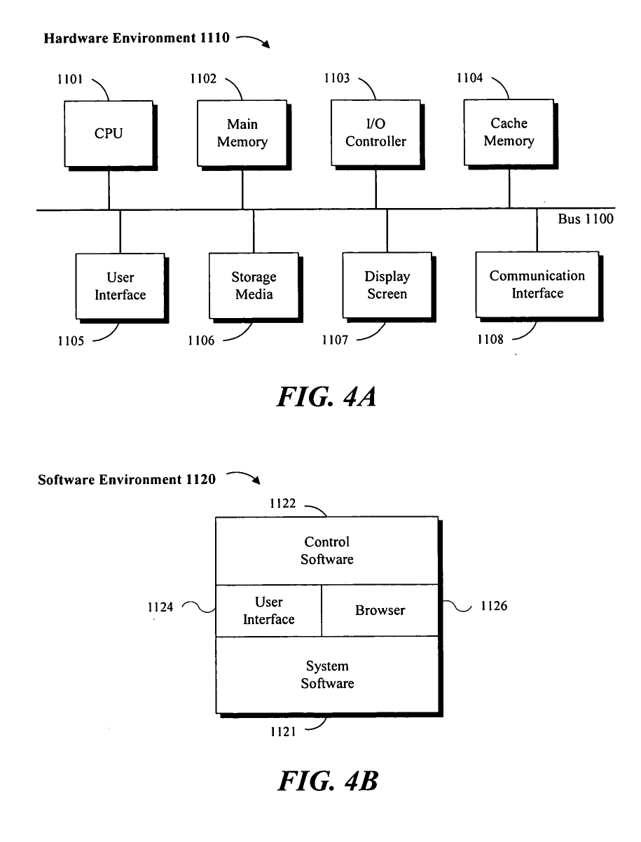

In one or more embodiments of the system, mobile device 100 comprises a controlled system environment that can be presented largely in terms of hardware components and software code executed to perform processes that achieve the results contemplated by the system of the present invention. A more detailed description of such system environment is provided below with reference to FIGS. 4A and 4B.

As shown, a computing system environment is composed of two environments, a hardware environment 1110 and a software environment 1120. The hardware environment 1110 comprises the machinery and equipment that provide an execution environment for the software. The software provides the execution instructions for the hardware. It should be noted that certain hardware and software components might be interchangeably implemented in either form, in accordance with different embodiments of the invention.

Referring to FIG. 4A, an embodiment of the control software 1122 can be implemented as logic code in the form of computer readable code executed on a general purpose hardware environment 1110 that comprises a central processor unit (CPU) 1101, a main memory 1102, an input/output controller 1103, optional cache memory 1104, a user interface 1105 (e.g., keypad, pointing device, etc.), storage media 1106 (e.g., hard drive, memory, etc.), a display screen 1107, a communication interface 1108 (e.g., a wireless network card, a Bluetooth port, a wireless modem, etc.), and a system synchronizer (e.g., a clock, not shown in FIG. 4A).

Cache memory 1104 is utilized for storing frequently accessed information. A communication mechanism, such as a bi-directional data bus 1100, can be utilized to provide for means of communication between system components. Hardware Environment 1110 is capable of communicating with local or remote systems connected to a wireless communications network (e.g., a PAN or a WAN) through communication interface 1108.

In one or more embodiments, hardware environment 1110 may not include all the above components, or may include additional components for additional functionality or utility. For example, hardware environment 1110 can be a laptop computer or other portable computing device that can send messages and receive data through communication interface 1108. Hardware environment 1110 may also be embodied in an embedded system such as a set-top box, a personal digital assistant (PDA), a wireless communication unit (e.g., cellular phone), or other similar hardware platforms that have information processing and/or data storage and communication capabilities.

In one embodiment of the system, communication interface 1108 can send and receive electrical, electromagnetic, or optical signals that carry digital data streams representing various types of information including program code. If communication is established via a communications network, hardware environment 1110 may transmit program code through the network connection. The program code can be executed by central processor unit 1101 or stored in storage media 1106 or other non-volatile storage for later execution.

Program code may be transmitted via a carrier wave or may be embodied in any other form of computer program product. A computer program product comprises a medium configured to store or transport computer readable code or a medium in which computer readable code may be embedded. Some examples of computer program products are memory cards, CD-ROM disks, ROM cards, floppy disks, magnetic tapes, computer hard drives, and network server systems.

In one or more embodiments of the invention, processor 1101 is a microprocessor manufactured by Motorola, Intel, or Sun Microsystems Corporations, for example. The named processors are for the purpose of example; thus, any other suitable microprocessor, microcontroller, or microcomputer may be utilized.

Referring to FIG. 4B, software environment 1120 or one or more of its components is stored in storage media 1106 and is loaded into memory 1102 prior to execution. Software environment 1120 comprises system software 1121 and control software 1122. Depending on implementation, certain aspects of software environment 1120, and particularly control software 1122, can be loaded on one or more hardware environments 1110, or subcomponents thereof.

System software 1121 comprises software such as an operating system that controls the low-level operations of hardware environment 1110. Low-level operations comprise the management of the system resources such as memory allocation, file swapping, and other core computing tasks. In one or more embodiments of the invention, the operating system can be Nucleus, Microsoft Windows, Macintosh OS, or Linux. However, any other suitable operating system may be utilized.

Control software 1122 can comprise one or more computer programs that are executed on top of system software 1121 after being loaded from storage media 1106 into memory 1102. In a client-server architecture, control software 1122 may comprise client software and/or server software executed on an integrated or distributed environment.

Software environment 1120 may also comprise web browser software 1126 for accessing content on a remote server. Further, software environment 1120 may comprise user interface software 1124 (e.g., a Graphical User Interface (GUI)) for receiving user commands and data. The received commands and data are processed by the software applications that run on the hardware environment 1110. The hardware and software architectures and environments described above are for purposes of example only. Embodiments of the invention may be implemented in any type of system architecture or processing environment.

Embodiments of the invention are described by way of example as applicable to systems and corresponding methods for controlling the illumination state of a mobile device. In this exemplary embodiment, logic code for performing these methods is implemented in the form of, for example, control software 1122. The logic code, in one embodiment, may be comprised of one or more modules that execute on one or more processors in a distributed or non-distributed communication model. For example, one or more embodiments of the present invention may comprise separate radio and baseband modules, or alternatively modules incorporating the radio, baseband, micro-controller and flash memory in a single-chip solution.

It should also be understood that the programs, modules, processes, methods, and the like, described herein are but exemplary implementations and are not related, or limited, to any particular computer, apparatus, or computer programming language. Rather, various types of general-purpose computing machines or customized devices may be used with logic code implemented in accordance with the teachings provided, herein. Further, the order in which the methods of the present invention are performed is purely illustrative in nature. These methods can be performed in any order or in parallel, unless indicated otherwise in the present disclosure.

The methods of the present invention may be performed in either hardware, software, or any combination thereof. In particular, some methods may be carried out by software, firmware, or macrocode operating on a single computer or a plurality of computers. Furthermore, such software may be transmitted in the form of a computer signal embodied in a carrier wave, and through communication networks by way of Internet portals or websites, for example. Accordingly, the present invention is not limited to any particular platform, unless specifically stated otherwise in the present disclosure.

The present invention has been described above with reference to preferred embodiments. However, those skilled in the art will recognize that changes and modifications may be made in these preferred embodiments without departing from the scope of the present invention. Other system architectures, platforms, and implementations that can support various aspects of the invention may be utilized without departing from the essential characteristics as described herein. These and various other adaptations and combinations of features of the embodiments disclosed are within the scope of the invention. The invention is defined by the claims and their full scope of equivalents.

1. An application sensitive illumination method for a mobile device, the method comprising:
detecting whether a first application is launched;
determining a first set of user interfaces of the mobile device associated with the first application for facilitating interaction with the first application; and
adjusting illumination of one or more illumination mechanisms that illuminate said first set of user interfaces of the mobile device based on an active status of the first application.

2. The method of claim 1, wherein the adjusting comprises increasing illumination intensity of the one or more illuminating mechanisms when the first application is active.

3. The method of claim 1, wherein the adjusting comprises decreasing illumination intensity of the one or more illuminating mechanisms when the first application is inactive.

4. The method of claim 1, wherein the adjusting comprises changing illumination color of the one or more illuminating mechanisms.

5. The method of claim 1, further comprising:
detecting whether a second application is launched;
determining a second set of user interfaces of the mobile device associated with the second application for facilitating interaction with the second application; and
adjusting illumination of one or more illumination mechanisms that illuminate said second set of user interfaces of the mobile device.

6. The method of claim 1, wherein the illumination of the one or more illumination mechanisms is returned to a default illumination state when the first application is inactive.

7. The method of claim 1, wherein the one or more illumination mechanisms comprise one or more backlights for lighting said first set of user interfaces.

8. The method of claim 1, wherein at least one of the illumination mechanisms is a light emitting diode (LED).

9. The method of claim 1, wherein the user interfaces comprise one or more keys on a keypad of the mobile device.

10. The method of claim 1, wherein the user interfaces comprise direction control means of the mobile device.

11. An application sensitive illumination method for a mobile device, the method comprising:
detecting whether a first application is launched;
determining a first set of keys of the mobile device associated with the first application;
illuminating the first set of keys;
detecting whether a second application is launched;
determining a second set of keys of the mobile device associated with the second application;
illuminating the second set of keys; and
un-illuminating the first set of keys.
